(19) United States
(12) Patent Application Publication
(10) Pub. No.: US 2011/0069749 A1
(43) Pub. Date: Mar. 24, 2011

(54) NONLINEAR EQUALIZER TO CORRECT FOR MEMORY EFFECTS OF A TRANSMITTER

(75) Inventors: Aracely Forrester, San Diego, CA (US); Philip David Coan, La Jolla, CA (US); Paul Draxler, San Diego, CA (US); Roberto Rimini, San Diego, CA (US); Bruce Judson, San Luis Obispo, CA (US); Joseph Patrick Burke, Glenview, IL (US)

(73) Assignee: QUALCOMM INCORPORATED, San Diego, CA (US)

(21) Appl. No.: 12/566,479

(22) Filed: Sep. 24, 2009

(51) Int. Cl. H04L 27/01

(52) U.S. Cl. 375/232

(57) ABSTRACT

Techniques for correcting for memory effects of a transmitter are described. In an exemplary design, a receiver obtains input samples including a desired signal transmitted by a transmitter having memory effects. The receiver performs nonlinear equalization on the input samples to obtain first equalized samples, performs linear equalization on the input samples to obtain second equalized samples, and determines output samples based on the first and second equalized samples. The nonlinear equalization corrects for the memory effects and nonlinearities of the transmitter and possibly nonlinearities and memory effects of the receiver. The receiver may jointly determine coefficients for both linear and nonlinear equalization based on an adaptive algorithm. The receiver processes (e.g., demodulates and decodes) the output samples to recover data sent in the desired signal by the transmitter.

### BACKGROUND

I. Field

The present disclosure relates generally to electronics, and more specifically to signal processing techniques.

II. Background

In a communication system, a transmitter may process (e.g., encode and modulate) data to generate output chips. The transmitter may further condition (e.g., convert to analog, filter, frequency upconvert, and amplify) the output chips to generate an output radio frequency (RF) signal. The transmitter may then transmit the output RF signal via a communication channel to a receiver. The receiver may receive the transmitted RF signal and perform the complementary processing on the received RF signal. The receiver may condition (e.g., amplify, frequency downconvert, filter, and digitize) the received RF signal to obtain input samples. The receiver may further process (e.g., demodulate and decode) the input samples to recover the transmitted data.

The transmitter typically includes a power amplifier (PA) to provide high transmit power for the output RF signal. Ideally, the power amplifier should be linear, and the output RF output should be linearly related to an input RF signal. However, in practice, the power amplifier typically has static nonlinearities as well as memory effects, as described below. The nonlinearities and memory effects of the power amplifier may generate distortion in the output RF signal, which may degrade performance.

### BRIEF DESCRIPTION OF THE DRAWINGS

FIG. 1 shows a block diagram of a transmitter and a receiver.

FIG. 2 illustrates memory effects of a power amplifier.

FIGS. 3A and 3B show two schemes for correcting for PA memory effects.

FIG. 4 shows a linear equalizer.

FIG. 5 shows a receive equalizer with linear and nonlinear equalization.

FIG. 6 shows a receive equalizer with linear and nonlinear FIR filters.

FIG. 7 shows a receiver with time-domain nonlinear equalizers.

FIG. 8 shows a receiver with frequency-domain nonlinear equalizers.

FIG. 9 shows a process for performing signal processing at a receiver.

### DETAILED DESCRIPTION

The word “exemplary” is used herein to mean “serving as an example, instance, or illustration.” Any design described herein as “exemplary” is not necessarily to be construed as preferred or advantageous over other designs.

A nonlinear equalizer that may be used at a receiver to correct for nonlinearities and memory effects of a transmitter is described herein. A linear equalizer is a circuit that receives input samples and provides output samples that are weighted sums of the input samples, as described below. A nonlinear equalizer is a circuit that receives input samples and provides output samples based on one or more nonlinear functions. In general, a nonlinear equalizer may be any equalizer that is not a linear equalizer. The memory effects of the transmitter may include memory effects of a power amplifier as well as memory effects of other circuits within the transmitter.

The nonlinear equalizer described herein may be used for various applications such as wireless communication, wireline communication, computing, networking, consumer electronics, etc. The nonlinear equalizer may also be used for base stations, user devices, etc. The user devices may be wireless communication devices, cellular phones, broadcast receivers, personal digital assistants (PDAs), handheld devices, wireless modems, laptop computers, cordless phones, wireless local loop (WLL) stations, Bluetooth devices, consumer electronics devices, etc. For clarity, the use of the nonlinear equalizer for wireless communication is described below.

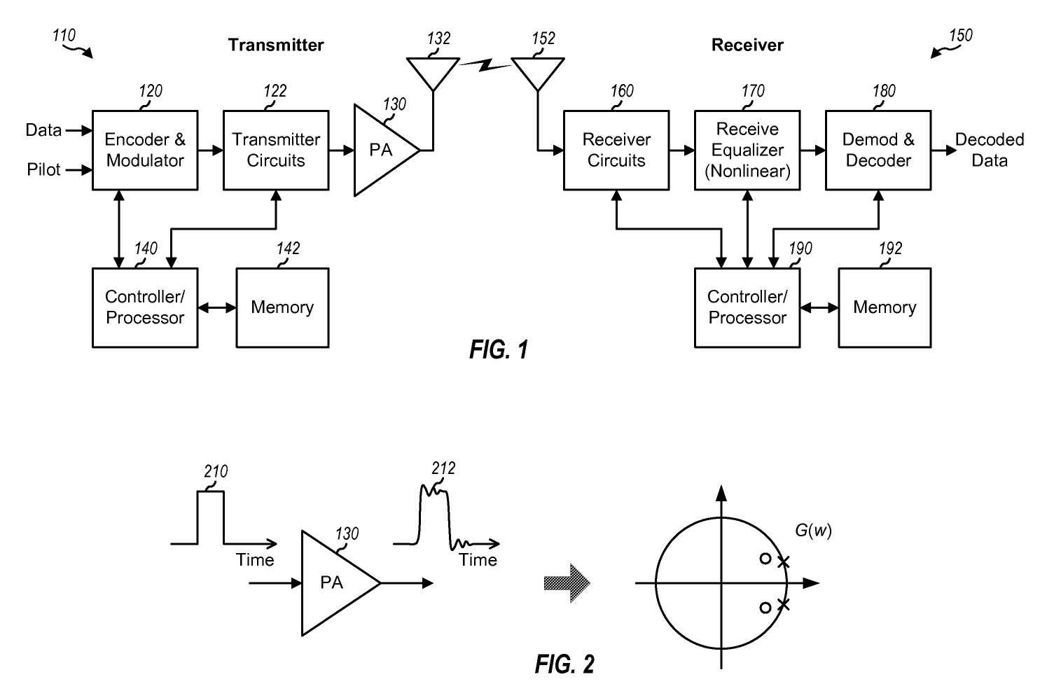

FIG. 1 shows a block diagram of an exemplary design of a transmitter 110 and a receiver 150 in a wireless communication system. For data transmission on the downlink, transmitter 110 may be part of a base station, and receiver 150 may be part of a user device. For data transmission on the uplink, transmitter 110 may be part of a user device, and receiver 150 may be part of a base station. A base station may also be referred to as a Node B, an evolved Node B (eNB), an access point, a base transceiver station (BTS), a relay, etc. A user device may also be referred to as a user equipment (UE), a mobile station, a terminal, an access terminal, a subscriber station, a station, etc.

At transmitter 110, an encoder and modulator 120 receives data to be transmitted, processes (e.g., encodes, interleaves, and symbol maps) the data, and provides data symbols. Encoder and modulator 120 also receives and processes pilot and provides pilot symbols. In general, a data symbol is a modulation symbol for data, a pilot symbol is a modulation symbol for pilot, and a modulation symbol is a real or complex value, e.g., for a modulation scheme such as BPSK, QPSK, QAM, etc. Pilot is data that is known a priori by both transmitter 110 and receiver 150 and may also be referred to as a reference signal. Encoder and modulator 120 may also process the data symbols and pilot symbols for code division multiplexing (CDM), orthogonal frequency division multiplexing (OFDM), single carrier frequency division multiplexing (SC-FDM), or some other modulation technique and may provide output chips. Transmitter circuits 122 then process (e.g., convert to analog, amplify, filter, and frequency upconvert) the output chips and provide an input RF signal. A power amplifier 130 amplifies the input RF signal to obtain the desired output power level and provides an output RF signal, which is transmitted via an antenna 132.

At receiver 150, an antenna 152 receives the transmitted RF signal and provides a received RF signal to receiver circuits 160. Receiver circuits 160 process (e.g., filter, amplify, frequency downconvert, and digitize) the received RF signal to obtain input samples. A receive equalizer 170 performs equalization on the input samples, as described below, and provides output samples. Receive equalizer 170 may comprise (i) a nonlinear equalizer to correct for nonlinearities and memory effects of power amplifier 130 and other circuits within transmitter 110 and (ii) a linear equalizer to correct for the response of a wireless channel from transmitter 110 to receiver 150. A demodulator (Demod) and decoder 180 processes the output samples (e.g., for CDM, OFDM, SC-FDM, etc.) to obtain demodulated symbols and further processes (e.g., symbol demaps, deinterleaves, and decodes) the demodulated symbols to obtain decoded data. In general, the processing by demodulator and decoder 180 at receiver 150 is complementary to the processing by encoder and modulator 120 at transmitter 110.

Controllers/processors 140 and 190 direct the operation of various units at transmitter 110 and receiver 150, respectively. Memories 142 and 192 store data and program codes for transmitter 110 and receiver 150, respectively.

Transmitter 110 may include circuits that have nonlinearities and memory effects. For clarity, certain parts of the description below cover refer to nonlinearities and memory effects of power amplifier 130. The PA nonlinearities may result from nonlinear characteristics of transistors used to implement power amplifier 130. The PA nonlinearities may be modeled with a power series, as follows:

v=g₁·u+g₂·u²+g₃·u³+ . . . , Eq (1)

where

g₁ is a linear gain between an input signal u and an output signal v,

g₂ is a coefficient that defines the strength of second-order nonlinearity, and

g₃ is a coefficient that defines the strength of third-order nonlinearity.

For simplicity, nonlinearity terms higher than third order are not shown in equation (1).

The PA memory effects may be defined as changes in the nonlinear characteristics of power amplifier 130 due to past history of an input signal. The PA memory effects may be due to various mechanisms such as thermal memory effects, electrical memory effects, bias effects, semiconductor trap effects, etc. Thermal memory effects may be attributed to dynamic changes in transistor junction temperature due to input power. Electrical memory effects may be primarily due to impedance variation over an input signal bandwidth around a carrier frequency, carrier frequency harmonics, and frequencies associated with a baseband signal. Bias effects relate to the power supply for power amplifier 130. Semiconductor trap effects are due to localized charges trapped in the substrate. The PA memory effects may cause deleterious effects such as intersymbol interference and may also degrade performance, which may be quantified by a higher error vector magnitude (EVM), a higher adjacent channel power ratio (ACPR), a higher bit error rate (BER), a higher packet error rate (PER), etc.

FIG. 2 illustrates PA memory effects, which may be characterized by an impulse response or a step response of power amplifier 130. An input pulse 210 may be applied to the input of power amplifier 130, which may provide an output pulse 212. Output pulse 212 may include ringing on both a low-to-high transition and a high-to-low transition. The step response of power amplifier 130 may be used to extract poles and zeros that characterize a transfer function G(ω) of power amplifier 130. In the example shown in FIG. 2, the transfer function G(ω) includes a pair of poles located on the unit circle and a pair of zeros located within the unit circle near the pole locations. In general, the transfer function G(ω) may be dependent on the memory characteristics of power amplifier 130, which may in turn be dependent on the design as well as the implementation of power amplifier 130.

In an aspect, nonlinearities and memory effects of power amplifier 130 and other circuits within transmitter 110 may be corrected with a nonlinear equalizer at receiver 150. Correcting for nonlinearities and memory effects of the transmitter may improve performance, as described below.

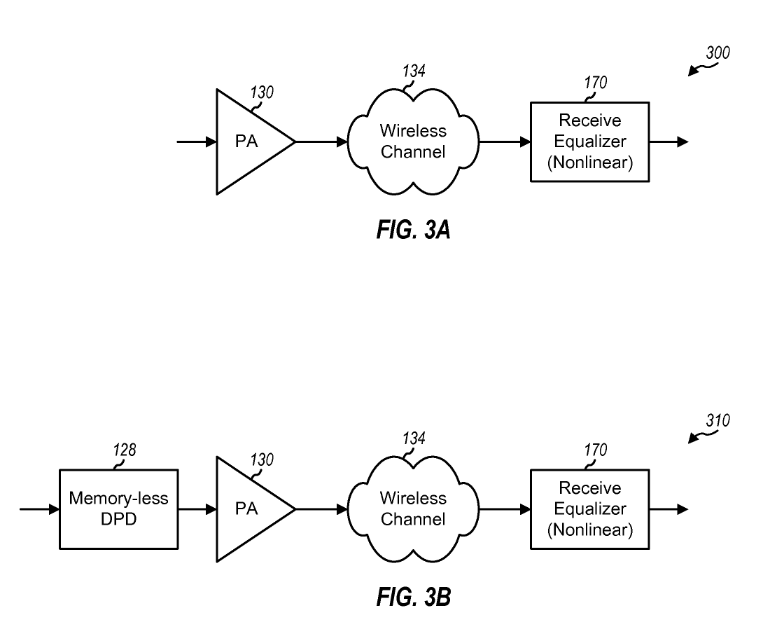

FIG. 3A shows a model 300 of an exemplary design of correcting for nonlinearities and memory effects of power amplifier 130. Model 300 includes power amplifier 130, a wireless channel 134 having a particular channel response, and receive equalizer 170 comprising a nonlinear equalizer. The channel response may be given by a time-domain channel impulse response h(τ) or an equivalent frequency-domain channel frequency response H(ω). For simplicity, other circuit blocks (e.g., receiver circuits 160) between power amplifier 130 and receive equalizer 170 may be assumed to have ideal linear responses.

In the exemplary design shown in FIG. 3A, receive equalizer 170 may correct for both nonlinearities and memory effects of power amplifier 130. Receive equalizer 170 may also perform equalization for wireless channel 134. Receive equalizer 170 may employ an adaptive algorithm to determine filter coefficients that can correct for PA effects and channel effects.

FIG. 3B shows a model 310 of another exemplary design of correcting for nonlinearities and memory effects of power amplifier 130. In this exemplary design, a memory-less digital pre-distortion (DPD) unit 128 is placed prior to power amplifier 130 (e.g., located within block 120 or 122 in FIG. 1) to correct for nonlinearities of power amplifier 130. Memory-less DPD unit 128 may correct for impairments to the output RF signal due to amplitude modulation to amplitude modulation (AM/AM) distortion and amplitude modulation to phase modulation (AM/PM) distortion of power amplifier 130. Performance improvement with memory-less DPD may be limited by the PA memory effects, especially for a wideband signal.

In FIG. 3B, receive equalizer 170 may perform nonlinear equalization to correct for memory effects of power amplifier 130 as well as residual nonlinearities of power amplifier 130 which are not corrected for by memory-less PDP unit 128. Receive equalizer 170 may also perform linear equalization for wireless channel 134. Receive equalizer 170 may employ an adaptive algorithm to determine filter coefficients that can correct for PA residual nonlinearities, PA memory effects, and channel effects. Using a combination of memory-less DPD at transmitter 110 and nonlinear equalization at receiver 150 may improve the linearity of power amplifier 130 and may result in improved efficiency and performance.

For clarity, FIGS. 2, 3A and 3B show nonlinearities and memory effects of power amplifier 130 as well as use of nonlinear equalization to correct for the nonlinearities and memory effects of power amplifier 130. The nonlinearities and memory effects of transmitter 110 may be illustrated in similar manners, e.g., by replacing power amplifier 130 with transmitter 110 in FIGS. 2, 3A and 3B. Nonlinear equalization may be used to correct for the nonlinearities and memory effects of the transmitter.

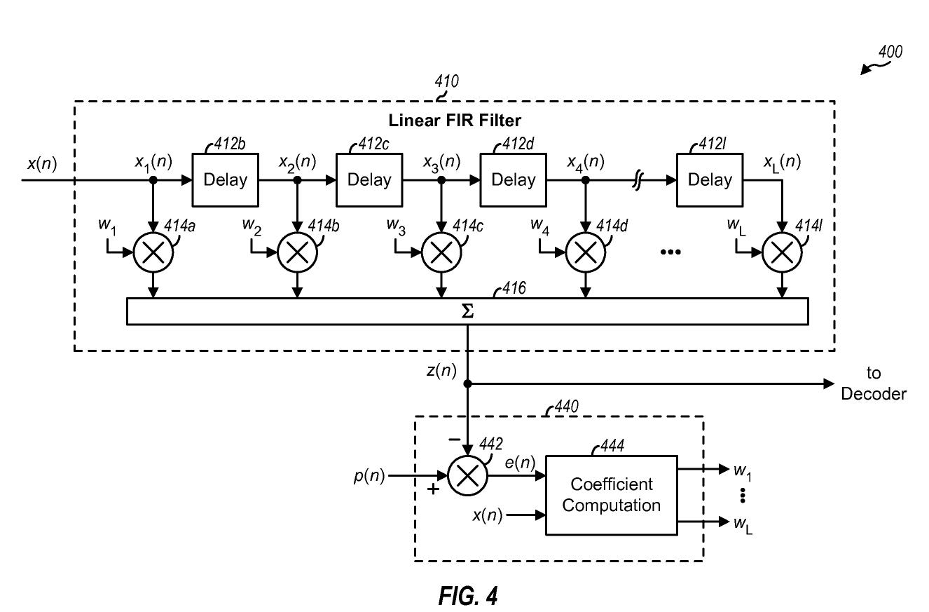

FIG. 4 shows a block diagram of a linear equalizer 400, which may be used for a receiver. Linear equalizer 400 may be able to correct for linear effects (e.g., channel effects) and may not be effective in correcting for nonlinearities and memory effects of power amplifier 130 and other circuits within transmitter 110. Linear equalizer 400 includes a linear finite impulse response (FIR) filter 410 and an adaptation unit 440. FIR filter 410 receives input samples x(n) from receiver circuits 160, filters the input samples with a set of coefficients w₁ to w_{L}, and provides output samples z(n). Adaptation unit 440 receives the output samples and pilot samples p(n) and determines the set of coefficients for FIR filter 410.

Within FIR filter 410, L−1 delay elements 412b through 412l are coupled in series, with the first delay element 412b receiving the input samples x(n). Each delay element 412 provides a delay of one sample period. L may be any suitable value and may be dependent on (e.g., may be longer than) the length of the channel impulse response. A multiplier 414a is coupled to the input of delay element 412b, and L−1 multipliers 414b through 414l are coupled to the outputs of delay elements 412b through 412l, respectively. Multipliers 414a through 414l receive L delayed input samples x₁(n) through x_{L}(n), respectively, and also receive L coefficients w₁ through w_{L}, respectively. Input sample x₁(n)=x(n) may be considered as a delayed input sample with a delay of zero. Each multiplier 414 multiplies its input sample with its coefficient and provides its result to a summer 416. Summer 416 sums the results from all L multipliers 414a to 414l and provides an output sample z(n).

Within adaptation unit 440, a summer 442 subtracts the output samples z(n) from pilot samples p(n) and provide errors e(n). The pilot samples may be generated by receiver 150 in the same manner as transmitter 110. A coefficient computation unit 444 receives the errors e(n) and the input samples x(n) and derives the coefficients w₁ to w_{L} for FIR filter 410 based on an adaptive algorithm. The adaptive algorithm may be a least square (LS) algorithm, a least mean square (LMS) algorithm, a recursive least square (RLS) algorithm, etc.

As noted above, linear equalizer 400 may be able to correct for the linear response of wireless channel 134 but may not be effective in correcting for nonlinearities and memory effects of power amplifier 130 and other circuits within transmitter 110.

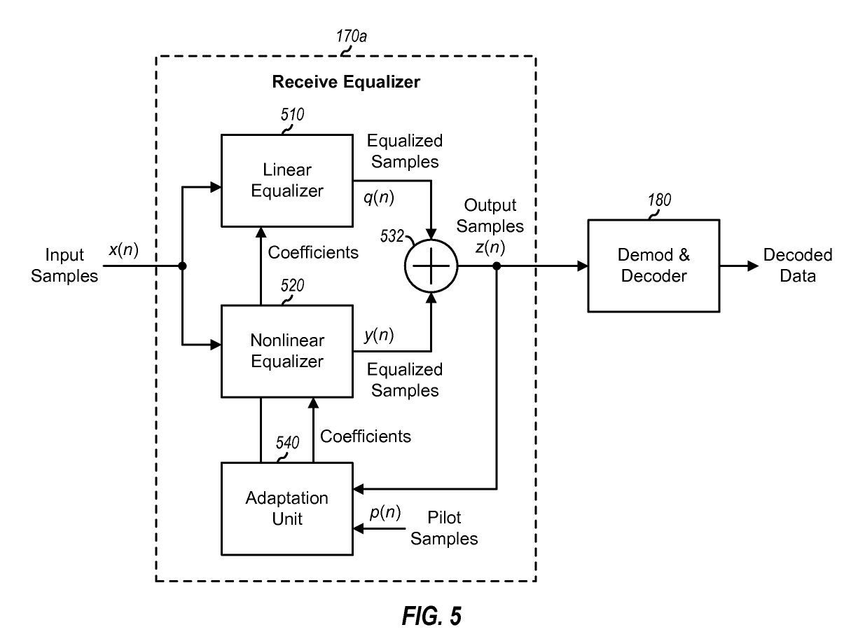

FIG. 5 shows a block diagram of an exemplary design of a receive equalizer 170a, which performs both linear and nonlinear equalization. Receive equalizer 170a can correct for channel effects as well as nonlinearities and memory effects of power amplifier 130 and other circuits within transmitter 110. Receive equalizer 170a is one exemplary design of receive equalizer 170 in FIG. 1.

Within receive equalizer 170a, a linear equalizer 510 receives the input samples x(n) from receiver circuits 160, filters the input samples with a first set of coefficients, and provides equalized samples q(n). A nonlinear equalizer 520 also receives the input samples x(n), generates intermediate samples based on the input samples and at least one nonlinear function, filters the intermediate samples with a second set of coefficients, and provides equalized samples y(n). A summer 532 sums the equalized samples q(n) from linear equalizer 510 and the equalized samples y(n) from nonlinear equalizer 520 and provides output samples z(n). The output samples z(n) thus include a linear component from linear equalizer 510 and a nonlinear component from nonlinear equalizer 520. An adaptation unit 540 receives the output samples and pilot samples and determines the first set of coefficients for linear equalizer 510 and the second set of coefficients for nonlinear equalizer 520.

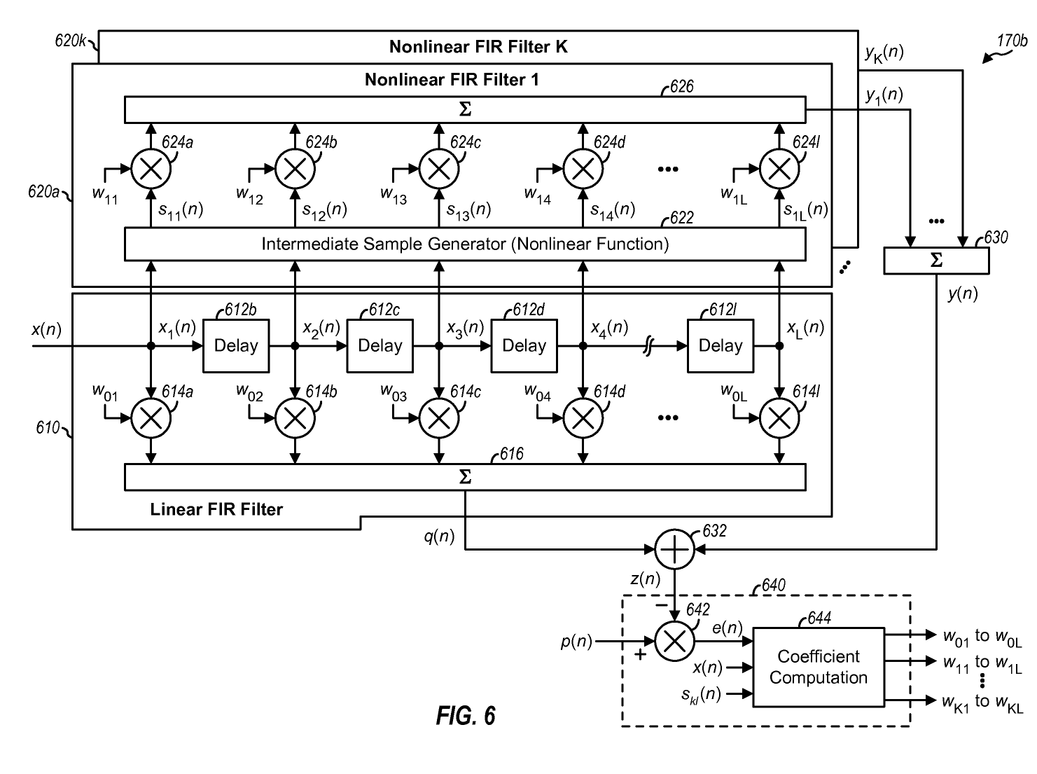

FIG. 6 shows a block diagram of an exemplary design of a receive equalizer 170b, which performs both linear and nonlinear equalization. Nonlinear equalizer 170b is one exemplary design of receive equalizer 170a in FIG. 5 and may be used for receive equalizer 170 in FIG. 1.

Receive equalizer 170b includes a linear FIR filter 610, K nonlinear FIR filters 620a to 620k, where K≧1, summers 630 and 632, and an adaptation unit 640. Linear FIR filter 610 filters the input samples whereas each nonlinear FIR filter 620 filters intermediate samples, which may be generated based on at least one nonlinear function of the input samples. A nonlinear function may include one or more nonlinear operations such as squaring (x²), cubing (x³), conjugation (x*), thresholding, etc. Linear FIR filter 610 may correspond to linear equalizer 510 in FIG. 5. Nonlinear FIR filters 620 and summer 630 may correspond to nonlinear equalizer 520 in FIG. 5.

Linear FIR filter 610 includes L−1 delay elements 612b through 6121, L multipliers 614a through 6141, and a summer 616, which are coupled in similar manner as delay elements 412b through 4121, multipliers 414a through 414l, and summer 416, respectively, in linear FIR filter 400 in FIG. 4. Linear FIR filter 610 receives input samples x(n) from receiver circuits 160, filters the input samples with a set of coefficients w₀₁ through w_{0L}, and provides equalized samples q(n).

Within each nonlinear FIR filter 620, an intermediate sample generator 622 receives the delayed input samples x₁(n) through x_{L}(n) from linear FIR filter 610 and determines a set of L intermediate samples sₖ₁(n) through s_{kL}(n) for that nonlinear FIR filter 620 based on the delayed input samples and a nonlinear function, where kε{1, . . . , K}. L multipliers 624a through 6241 receive the L intermediate samples sₖ₁(n) through s_{kL}(n), respectively, and also receive L coefficients wₖ₁ through w_{kL}, respectively, for the nonlinear FIR filter. Each multiplier 624 multiplies its intermediate sample with its coefficient and provides its result to a summer 626. Summer 626 sums the results from all L multipliers 624a through 624l and provides a filtered sample yₖ(n) for the nonlinear FIR filter.

The K nonlinear FIR filters 620a through 620k may be for different orders of nonlinearity and may generate K different sets of intermediate samples. In particular, intermediate samples s₁₁(n) through s_{1L}(n) may be generated for the first nonlinear FIR filter 620a, and so on, and intermediate samples s_{K1}(n) through s_{KL}(n) may be generated for the last nonlinear FIR filter 620k. The K nonlinear FIR filters 620a through 620k also receive K different sets of coefficients. In particular, the first nonlinear FIR filter 620a may receive coefficients w₁₁ through w_{1L}, and so on, and the last nonlinear FIR filter 620k may receive coefficients w_{K1} through w_{KL}. The K nonlinear FIR filters 620a through 620k may implement different nonlinear functions to generate their intermediate samples and may provide K filtered samples y₁(n) through y_{K}(n) in each sample period. Summer 630 sums the K filtered samples y₁(n) through y_{K}(n) from all K nonlinear FIR filters 620a through 620k and provides an equalized sample y(n).

Summer 632 sums the equalized sample q(n) from linear FIR filter 610 and the equalized sample y(n) from summer 630 and provides output samples z(n). The output samples z(n) thus include a linear component from linear FIR filter 610 and a nonlinear component from nonlinear FIR filters 620a through 620k.

Adaptation unit 640 receives the output samples z(n), the input samples x(n), the intermediate samples sₖᵢ (n), and pilot samples p(n) and determines the coefficients for FIR filters 610 and 620. Within adaptation unit 640, a summer 642 subtracts the output samples z(n) from the pilot samples p(n) and provide errors e(n). A coefficient computation unit 644 receives the errors e(n), the input samples x(n), and the intermediate samples sₖᵢ (n) and derives the coefficients for all FIR filters 610 and 620 based on an adaptive algorithm. The adaptive algorithm may be an LS algorithm, an LMS algorithm, an RLS algorithm, etc.

In general, nonlinear FIR filters 620 may implement any nonlinear function that can correct for nonlinearities and memory effects of power amplifier 130 and other circuits within transmitter 110. In an exemplary design, nonlinear FIR filters 620 implement an adaptive Volterra filter that can model nonlinearity and memory effects based on a Volterra series. The Volterra series may be expressed as:

$$y ( n ) = {\sum }_{p = 1}^{P} {\sum }_{{i}_{1} = 0}^{M} {\sum }_{{i}_{2} = 1}^{M} … {\sum }_{{i}_{p} = {i}_{p - 1}}^{M} {h}_{p} ( {i}_{1} , {i}_{2} , … , {i}_{p} ) \cdot \underbrace{x ( n - {i}_{1} ) \cdot x ( n - {i}_{2} ) … x ( n - {i}_{p} )}_{{s}_{p} ( {i}_{1} , {i}_{2} , … , {i}_{p} )} , \qquad Eq ( 2 )$$

where

x(n) denotes an input sample,

y(n) denotes an output sample,

hₚ(i₁, i₂, . . . , iᵣ) denotes Volterra kernels for p-th order nonlinearity,

sₚ(i₁, i₂, . . . , iᵣ) denotes intermediate samples for p-th order nonlinearity,

M is the memory length, and

P is the order of nonlinearity.

As shown in equation (2), the output sample y(n) may be obtained by a weighted sum of intermediate samples. Each intermediate sample may correspond to a product of different delayed input samples. The intermediate samples are weighted by the Volterra kernels to obtain the output sample. Memory effects may be captured by using the current input sample as well as prior input samples in computing the output sample.

The nonlinearities and memory effects of power amplifier 130 and other circuits within transmitter 110 may be modeled with the Volterra series. Nonlinear FIR filters 620 may then implement the inverse of the Volterra series in order to correct for the nonlinearities and memory effects. Equivalently, the inverse of the nonlinearities and memory effects may be represented with the Volterra series. Nonlinear FIR filters 620 may then implement the Volterra series to correct for the nonlinearities and memory effects. The Volterra series may thus be used to model the actual nonlinearities and memory effects or the inverse. The intermediate samples may be the same regardless of whether the Volterra series is used to model the actual or inverse nonlinearities and memory effects. The Volterra kernels may be different depending on whether the Volterra series is used to model the actual or inverse nonlinearities and memory effects.

In an exemplary design, each nonlinear FIR filter 620 may implement a different order of nonlinearity. In particular, nonlinear FIR filter 620a may implement first order nonlinearity, and so on, and nonlinear FIR filter 620k may implement K-th order nonlinearity. Generator 622 in each nonlinear FIR filter 620 may generate the intermediate samples for the corresponding order of nonlinearity. The coefficients for each nonlinear FIR filter 620 may correspond to the Volterra kernels for the corresponding order of nonlinearity. Nonlinear FIR filters 620a through 620k may have different lengths (or different values of L), and the length of each nonlinear FIR filter 620 may be selected to be L≧M+K.

As shown in equation (2), the Volterra series may include a large number of Volterra kernels and a large number of intermediate samples, especially for higher order of nonlinearity. Various simplifications may be made to reduce the complexity of the adaptive Volterra filter.

The Volterra series may also be expressed as:

$$y ( n ) = {\sum }_{p = 1}^{P} {h}_{p , 0} ( 0 , 0 , … , 0 ) \cdot {x}^{p} ( n ) + {\sum }_{p = 1}^{P} \{ {\sum }_{r = 1}^{p} [ \begin{matrix}{x}^{p - r} ( n ) \cdot {\sum }_{{i}_{1} = 1}^{M} … {\sum }_{{i}_{r} = {i}_{r - 1}}^{M} \\ {h}_{p , r} ( 0 , … , 0 , {i}_{1} , … , {i}_{r} ) \cdot \underbrace{{\prod }_{j = 1}^{r} x ( n - {i}_{j} )}_{{s}_{p , r} ( )}\end{matrix} ] \} \qquad Eq ( 3 )$$

where
r denotes the order of the dynamics,
s_{p,r}( ) denotes intermediate samples for p-th order nonlinearity and r-th order dynamics, and
h_{p,r}( ) denotes Volterra kernels for p-th order nonlinearity and r-th order dynamics.

The effects of dynamics typically fade with higher order nonlinearity for power amplifier 130. The Volterra series may be simplified by considering only lower order dynamics. For example, if only first-order dynamics are considered and r=1, then equation (3) may be simplified as follows:

$$y ( n ) = {\sum }_{j = 0}^{( P - 1 ) / 2} {\sum }_{i = 0}^{M} {h}_{2 j + 1 , 1} ( i ) \cdot \underbrace{{\vert x ( n ) \vert}^{2 j} \cdot x ( n - i )}_{{s}_{2 j + 1 , 1} ( i )} + {\sum }_{j = 1}^{( P - 1 ) / 2} {\sum }_{i = 1}^{M} {h}_{2 j + 1 , 2} ( i ) \cdot \underbrace{{\vert x ( n ) \vert}^{2 ( j - 1 )} \cdot {x}^{2} ( n ) \cdot {x}^{*} ( n - i )}_{{s}_{2 j + 1 , 2} ( i )} \qquad Eq ( 4 )$$

where

s_{2j+1,1}(i) and s_{2j+1,2}(i) denote intermediate samples, and

h_{2j+1,1}(i) and h_{2j+1,1}(i) denote Volterra kernels.

In an exemplary design, nonlinear FIR filters 620 may implement equation (4). The first (P−1)/2+1 nonlinear FIR filters 620 may have M+1 taps and may implement the first pair of summations in equation (4). The last (P−1)/2 nonlinear FIR filters 620 may have M taps and may implement the second pair of summations in equation (4). Generator 622 in each nonlinear FIR filter 620 may determine the intermediate samples s_{2j+1,1}(i) or s_{2j+1,2} (i) for that nonlinear FIR filter. Coefficient computation unit 644 may adaptively determine the Volterra kernels for all nonlinear FIR filters 620.

The nonlinearities and memory effects of power amplifier 130 and other circuits within transmitter 110 (or the inverse) may be modeled with the Volterra series, as described above. Receive equalizer 170 may then implement an adaptive Volterra filter to correct for the nonlinearities and memory effects. The adaptive Volterra filter may be implemented with nonlinear FIR filters 620 in FIG. 6 or with filters of other types.

The nonlinearities and memory effects of power amplifier 130 and other circuits within transmitter 110 (or the inverse) may also be modeled with other nonlinear functions instead of the Volterra series. A nonlinear function may operate on both current and prior input samples to model memory effects. The nonlinear function may also utilize one or more nonlinear operations to model nonlinearity. For example, the nonlinear function may utilize a cubic metric model or some other simple nonlinear function. Generator 622 in each nonlinear FIR filter 620 may implement any nonlinear function to generate the intermediate samples for that nonlinear FIR filter. For example, generator 622 may implement a magnitude squared operation, a 4th-order operation, conjugation, etc. Different nonlinear FIR filters 620 may implement different nonlinear functions, e.g., for different orders of nonlinearity.

In the exemplary design shown in FIG. 6, generator 622 in each nonlinear FIR filter 620 may implement one or more nonlinear operations to generate the intermediate samples for that nonlinear FIR filter. Multipliers 624 and summer 626 in each nonlinear FIR filter 620 may operate in similar manner as multipliers 614 and summer 616 in linear FIR filter 610. The filtered sample from each nonlinear FIR filter 620 may thus be a weighted sum of the intermediate samples. The output sample z(n) in each sample period may be expressed as:

z(n)=x(n)w(n), Eq (5)
where x(n)=[x₁(n) . . . x_{L}(n) . . . s₁₁(n) . . . s_{1L}(n) . . . s_{K1}(n) . . . s_{KL}(n)] is a 1×T row vector of input samples and intermediate samples for FIR filters 610 and 620 in sample period n, with T=(K+1)·L, and
   w(n)=[w₀₁(n) . . . w_{0L}(n) w₁₁(n) . . . w_{1L}(n) . . . w_{K1}(n) . . . w_{KL}(n)] is a T×1 column vector of coefficients for FIR filters 610 and 620 in sample period n.

Coefficient computation unit 644 may jointly and adaptively determine the coefficients for all FIR filters 610 and 620. Unit 644 may treat the output sample z(n) as being equal to a weighted sum of the input samples and the intermediate samples, without having to take into account how the intermediate samples are generated. Unit 644 may then adaptively determine the coefficients for FIR filters 610 and 620 based on any linear adaptive algorithm.

In one exemplary design, unit 644 may adaptively determine the coefficients for FIR filters 610 and 620 based on the LS algorithm, as follows:

w(n+1)=[x^{H}(n)x(n)]⁻¹x^{H}(n)·z(n), Eq (6)

where “^{H}” denotes a Hermetian or conjugate transpose.

As shown in equation (6), the coefficients may be updated in each sample period based on the input samples, the intermediate samples, and the output sample for that sample period. The coefficients may also be averaged over multiple sample periods to reduce noise.

In another exemplary design, unit 644 may adaptively determine the coefficients for FIR filters 610 and 620 based on the LMS algorithm, as follows:

w(n+1)=w(n)+x(n)·μ·e*(n), Eq (7)

where μ is an adaptation constant that determines the rate of convergence, and

“*” denotes a complex conjugate.

In yet another exemplary design, unit 644 may adaptively determine the coefficients for FIR filters 610 and 620 based on the RLS algorithm, as follows:

$$\begin{matrix}c ( n ) = \frac{P ( n ) {x}^{H} ( n )}{λ + x ( n ) P ( n ) {x}^{H} ( n )} , & Eq ( 8 ) \\ w ( n + 1 ) = w ( n ) + c ( n ) \cdot {e}^{*} ( n ) , & Eq ( 9 ) \\ P ( n + 1 ) = {λ}^{- 1} P ( n ) - {λ}^{- 1} c ( n ) x ( n ) P ( n ) , & Eq ( 10 )\end{matrix}$$

where λ is a memory weighting factor.

For the RLS algorithm, P(n) is an inverse correlation matrix that may be initialized as P(n)=δI, where δ may be a small positive value and I is an identity matrix.

In the exemplary designs shown in equations (6) through (10), the coefficients for linear FIR filter 610 and nonlinear FIR filters 620 may be jointly determined using the LS, LMS or RLS algorithm. In other exemplary designs, the coefficients for linear FIR filter 610 may be determined independently of the coefficients for nonlinear FIR filters 620. Unit 644 may determine each set of coefficients based on appropriate samples and using the LS, LMS or RLS algorithm.

The coefficients for FIR filters 610 and 620 may also be determined based on known aspects of the system in order to ensure convergence of the coefficients in an efficient manner. For example, a term may be broken down into a number of components such as time invariant components, components that are correlated with other users and received power, components that are correlated with the transmit power/state of the users, components for slow and fast time variant channel effects, etc.

As noted above, nonlinear equalizers may be used at both (i) a base station to correct for nonlinearities and memory effects of transmitters at user devices and (ii) a user device to correct for nonlinearities and memory effects of transmitters at base stations. The nonlinear equalizers may be implemented in different manners depending on system design, e.g., depending on how data and pilot are transmitted.

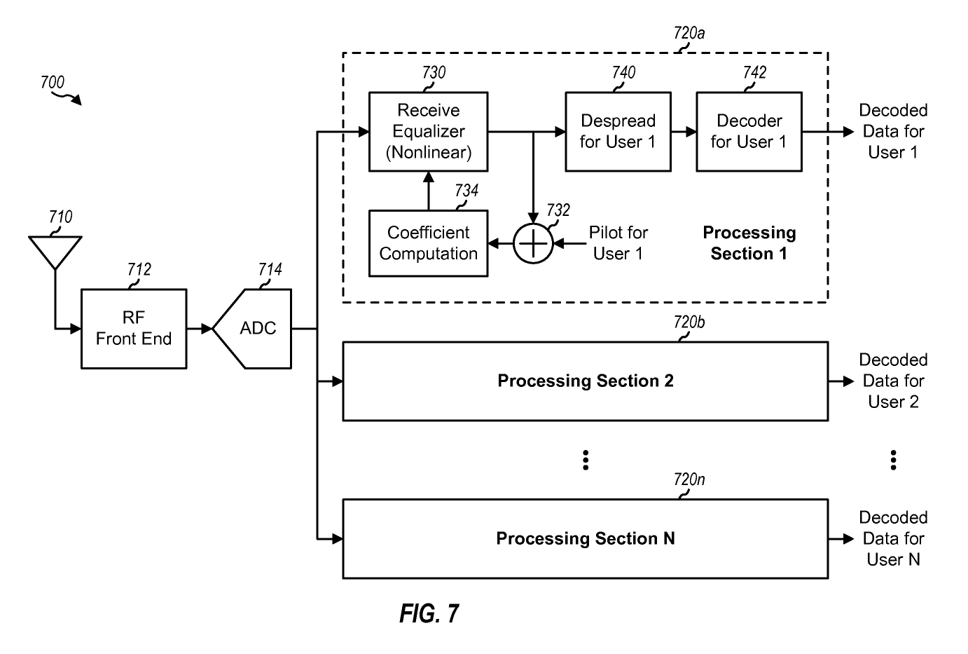

FIG. 7 shows a block diagram of an exemplary design of a receiver 700 with time-domain nonlinear equalizers. Receiver 700 may be used for base stations in systems in which pilot is sent in the time domain, such as Code Division Multiple Access (CDMA) systems, Time Division Multiple Access (TDMA) systems, etc. For example, receiver 700 may be used for CDMA 1X systems, Wideband CDMA (WCDMA) systems, Global System for Mobile Communications (GSM) systems, etc.

At receiver 700, an antenna 710 receives RF signals transmitted by different user devices and provides a received RF signal to an RF front end 712. RF front end 712 processes (e.g., filters, amplifies, and frequency downconverts) the received RF signal and provides a baseband signal. An analog-to-digital converter (ADC) 714 digitizes the baseband signal at a sampling rate of fₛₐₘₚ and provides input samples to N processing sections 720a through 720n, where N≧1. The sampling rate may be multiple times (e.g., 2, 4 or 8 times) the chip rate. Each processing section 720 may be assigned to process a signal from a particular user.

Within processing section 720a for the first user, a receive equalizer 730 filters the input samples and provides output samples. Receive equalizer 730 may comprise a linear equalizer and a nonlinear equalizer (e.g., as shown in FIG. 5) and may be implemented with linear FIR filter 610 and nonlinear FIR filters 620 in FIG. 6. Receive equalizer 730 may also be implemented in other manners, e.g., with other types of filter in additional to or instead of FIR filters. Receive equalizer 730 may also perform downsampling from the sampling rate to the chip rate. A summer 732 subtracts the output samples from pilot samples and provides errors. A coefficient computation unit 734 determines the coefficients for receive equalizer 730 based on the input samples and the errors and using the LS, LMS, RLS or some other adaptive algorithm. Unit 734 may be enabled when pilot from the first user is present and may be disabled at other times. The linear and nonlinear equalization by receive equalizer 730 may correct for nonlinearities and memory effects of a transmitter used by the first user as well as the response of a wireless channel from the first user to the base station. A despreader 740 despreads the output samples from receive equalizer 730 with one or more Wash codes assigned to the first user and provides despread symbols. A decoder 742 decodes the despread symbols and provides decoded data for the first user.

Each remaining processing section 720 may similarly process the input samples for its assigned user. The pilot samples for each user may be generated in the same manner performed by that user, e.g., based on a scrambling sequence or a pseudo-random number (PN) sequence assigned to the user. The despreading for each user may be dependent on the Walsh code(s) assigned to that user. The decoding for each user may be dependent on the coding scheme used by that user.

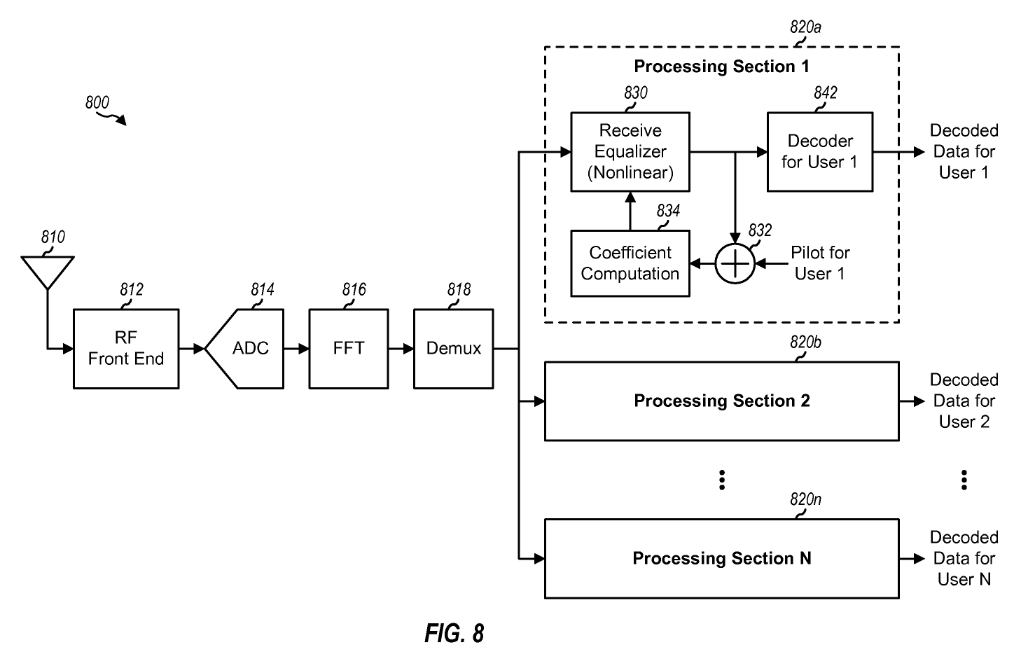

FIG. 8 shows a block diagram of an exemplary design of a receiver 800 with frequency-domain nonlinear equalizers. Receiver 800 may be used for base stations in systems in which pilot is sent in the frequency domain, such as Orthogonal Frequency Division Multiple Access (OFDMA) systems, Single Carrier FDMA (SC-FDMA) systems, etc. For example, receiver 800 may be used for a Long Term Evolution (LTE) system that utilizes OFDMA on the downlink and SC-FDMA on the uplink.

At receiver 800, an antenna 810 receives RF signals transmitted by different user devices and provides a received RF signal to an RF front end 812. RF front end 812 processes the received RF signal and provides a baseband signal. An ADC 814 digitizes the baseband signal and provides input samples. A fast Fourier transform (FFT) unit 816 transforms the input samples to the frequency domain and provides input symbols. A demultiplexer (Demux) 818 demultiplexes the input symbols from different subcarriers assigned to different users and provides the input symbols for N users to N processing sections 820a through 820n, where N≧1. Each processing section 820 may be assigned to process a signal from a particular user.

Within processing section 820a for the first user, a receive equalizer 830 filters the input symbols and provides output symbols. Receive equalizer 830 may comprise a linear equalizer and a nonlinear equalizer (e.g., as shown in FIG. 5) and may be implemented with linear FIR filter 610 and nonlinear FIR filters 620 in FIG. 6. Receive equalizer 830 may also be implemented in other manners, e.g., with other types of filter in additional to or instead of FIR filters. A summer 832 subtracts the output symbols from pilot symbols and provides errors. A coefficient computation unit 834 determines the coefficients for receive equalizer 830 based on the input symbols and the errors and using the LS, LMS, RLS or some other adaptive algorithm. Unit 834 may be enabled when pilot from the first user is present and may be disabled at other times. The linear and nonlinear equalization by receive equalizer 830 may correct for nonlinearities and memory effects of a transmitter used by the first user as well as the response of a wireless channel from the first user to the base station. A decoder 842 decodes the output symbols and provides decoded data for the first user.

Each remaining processing section 820 may similarly process the input symbols for its assigned user. The pilot symbols for each user may be generated in the same manner performed by that user.

In the exemplary designs shown in FIGS. 7 and 8, nonlinear equalization may be performed at a base station to correct for nonlinearities and memory effects of transmitters at different user devices. These exemplary designs may improve performance for the user devices with minimal impact to the design and power dissipation of the user devices. The complexity of correcting for nonlinearities and memory effects may thus be transferred from the user devices to the base station, which may be desirable.

The nonlinear equalizer described herein can correct for nonlinearities and memory effects of a power amplifier and other circuits (e.g., mixers, amplifiers, etc.) in a transmitter, as described above. The nonlinear equalizer can also correct for nonlinearities and memory effects of circuits (e.g., amplifiers, mixers, etc.) in a receiver. Degradation in performance due to nonlinearities and memory effects may be worse for wideband signals, such as signals in LTE, UMB, WiMAX, and WLAN systems. The nonlinear equalizer may thus be especially beneficial in newer systems using wideband signals.

The nonlinear equalizer described herein can perform nonlinear equalization using existing pilot signals, without requiring additional feedback information. The nonlinear equalizer can also improve performance without requiring the transmitter to use a larger power amplifier that may consume more battery power. The improvement may be observed at the receiver after the nonlinear equalizer. Thus, user devices (or transmitters) may be tested with a nonlinear equalizer at a base station (or a receiver) to determine the overall performance (e.g., EVM). This testing method may relax certain requirements of the user devices since the output RF signals from the user devices may be degraded due to nonlinearities and memory effects that can be corrected for by the nonlinear equalizer at the base station.

The nonlinear equalizer described herein may be implemented digitally, e.g., as shown in FIG. 6. Nonlinear equalization may also be performed with analog circuits. For example, a nonlinear FIR filter may be implemented with a discrete time FIR filter and an intermediate sample generator, which may be implemented with various analog circuits having nonlinear characteristics.

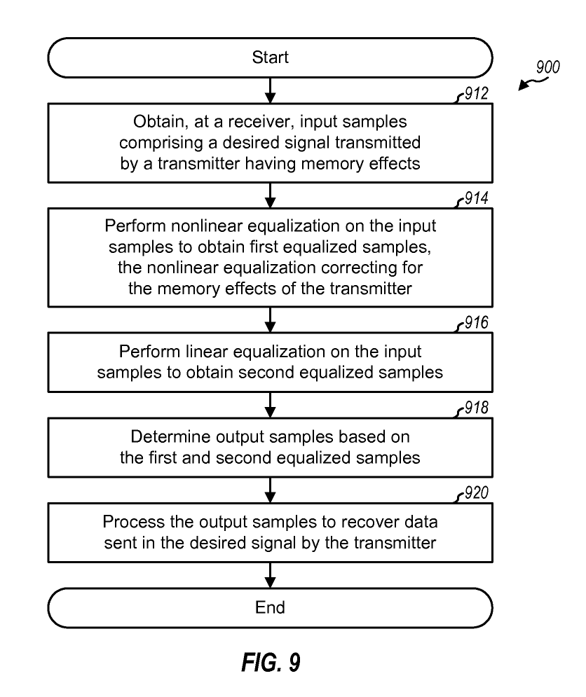

FIG. 9 shows an exemplary design of a process 900 for performing signal processing at a receiver. The receiver may obtain input samples comprising a desired signal transmitted by a transmitter having memory effects (block 912). For example, the desired signal may be amplified at the transmitter by a power amplifier having memory effects. The receiver may perform nonlinear equalization on the input samples to obtain first equalized samples (block 914). The nonlinear equalization may correct for the memory effects of the transmitter and may also correct for memory effects of the receiver. The receiver may also perform linear equalization on the input samples to obtain second equalized samples (block 916). The receiver may determine output samples based on the first and second equalized samples (block 918). The receiver may perform the linear and nonlinear equalization jointly to obtain the output samples, and the equalized samples may be implicit instead of explicit. The receiver may also perform the linear and nonlinear equalization in the time domain (e.g., as shown in FIG. 7) or in the frequency domain (e.g., as shown in FIG. 8). In any case, the receiver may process (e.g., demodulate and decode) the output samples to recover data sent in the desired signal by the transmitter (block 920).

In an exemplary design, the receiver may jointly determine first coefficients for the nonlinear equalization and second coefficients for the linear equalization based on an adaptive algorithm, e.g., an LS algorithm, an LMS algorithm, or an RLS algorithm. The receiver may determine errors between the output samples and pilot samples for the transmitter and may determine the coefficients based on the errors and the adaptive algorithm, as described above.

In an exemplary design of block 914, the receiver may determine intermediate samples based on the input samples and at least one nonlinear function, e.g., a Volterra series. The receiver may determine the intermediate samples based on products of input samples with different delays, e.g., as shown in equation (2), (3) or (4). The receiver may also determine the intermediate samples with other nonlinear operations or functions. The receiver may filter the intermediate samples to obtain the first equalized samples. In an exemplary design, the receiver may filter the intermediate samples with at least one FIR filter, e.g., as shown in FIG. 6. Each FIR filter may filter a respective set of intermediate samples with a respective set of coefficients. The at least one FIR filter may correct for at least one order of nonlinearity. The receiver may determine the coefficients for the at least one FIR filter based on an adaptive algorithm.

In an exemplary design, the desired signal may be pre-distorted at the transmitter, e.g., to correct for nonlinearities of the power amplifier, as shown in FIG. 3B. The nonlinear equalization at the receiver may then correct for residual nonlinearities not corrected by the pre-distortion at the transmitter.

In an exemplary design, the receiver may be for a base station, and the transmitter may be for a user device. In another exemplary design, the receiver may be for a user device, and the transmitter may be for a base station. The receiver and transmitter may also be for other stations or devices.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of performing signal processing at a receiver, comprising:
obtaining input samples comprising a desired signal transmitted by a transmitter having memory effects; and
performing nonlinear equalization on the input samples to obtain first equalized samples, the nonlinear equalization correcting for the memory effects of the transmitter.

2. The method of claim 1, further comprising:
performing linear equalization on the input samples to obtain second equalized samples;
determining output samples based on the first and second equalized samples; and
processing the output samples to recover data sent in the desired signal by the transmitter.

3. The method of claim 2, further comprising:
jointly determining first coefficients for the nonlinear equalization and second coefficients for the linear equalization based on an adaptive algorithm.

4. The method of claim 3, the jointly determining the first and second coefficients comprising
determining errors between the output samples and pilot samples for the transmitter, and
determining the first and second coefficients based on the errors and the adaptive algorithm.

5. The method of claim 3, the adaptive algorithm being a least square (LS) algorithm, a least mean square (LMS) algorithm, or a recursive least square (RLS) algorithm.

6. The method of claim 1, the performing nonlinear equalization comprising
determining intermediate samples based on the input samples and at least one nonlinear function, and
filtering the intermediate samples to obtain the first equalized samples.

7. The method of claim 6, the determining the intermediate samples comprising determining the intermediate samples based on the input samples and a Volterra series for the at least one nonlinear function.

8. The method of claim 6, the determining the intermediate samples comprising determining the intermediate samples based on products of input samples with different delays.

9. The method of claim 6, the filtering the intermediate samples comprising filtering the intermediate samples with at least one finite impulse response (FIR) filter, each FIR filter filtering a respective set of intermediate samples with a respective set of coefficients.

10. The method of claim 9, the at least one FIR filter correcting for at least one order of nonlinearity.

11. The method of claim 1, the desired signal being pre-distorted at the transmitter to correct for nonlinearities of a power amplifier at the transmitter, and the nonlinear equalization correcting for residual nonlinearities not corrected by the pre-distortion at the transmitter.

12. An apparatus for performing signal processing at a receiver, comprising:
at least one processor to obtain input samples comprising a desired signal transmitted by a transmitter having memory effects, and to perform nonlinear equalization on the input samples to obtain first equalized samples, the nonlinear equalization correcting for the memory effects of the transmitter.

13. The apparatus of claim 12, the at least one processor performs linear equalization on the input samples to obtain second equalized samples, determines output samples based on the first and second equalized samples, and processes the output samples to recover data sent in the desired signal by the transmitter.

14. The apparatus of claim 13, the at least one processor jointly determines first coefficients for the nonlinear equalization and second coefficients for the linear equalization based on an adaptive algorithm.

15. The apparatus of claim 12, the at least one processor determines intermediate samples based on the input samples and at least one nonlinear function, and filters the intermediate samples to obtain the first equalized samples.

16. The apparatus of claim 15, the at least one processor determines the intermediate samples based on the input samples and a Volterra series for the at least one nonlinear function.

17. The apparatus of claim 15, the at least one processor filters the intermediate samples with at least one finite impulse response (FIR) filter, each FIR filter filtering a respective set of intermediate samples with a respective set of coefficients.

18. The apparatus of claim 12, the transmitter being part of a user device, and the receiver being part of a base station.

19. An apparatus for performing signal processing at a receiver, comprising:
means for obtaining input samples comprising a desired signal transmitted by a transmitter having memory effects; and
means for performing nonlinear equalization on the input samples to obtain first equalized samples, the nonlinear equalization correcting for the memory effects of the transmitter.

20. The apparatus of claim 19, further comprising:
means for performing linear equalization on the input samples to obtain second equalized samples;
means for determining output samples based on the first and second equalized samples; and
means for processing the output samples to recover data sent in the desired signal by the transmitter.

21. The apparatus of claim 20, further comprising:
means for jointly determining first coefficients for the nonlinear equalization and second coefficients for the linear equalization based on an adaptive algorithm.

22. The apparatus of claim 19, the means for performing nonlinear equalization comprising
means for determining intermediate samples based on the input samples and at least one nonlinear function, and
means for filtering the intermediate samples to obtain the first equalized samples.

23. The apparatus of claim 22, the means for determining the intermediate samples comprising means for determining the intermediate samples based on the input samples and a Volterra series for the at least one nonlinear function.

24. The apparatus of claim 22, the means for filtering the intermediate samples comprising means for filtering the intermediate samples with at least one finite impulse response (FIR) filter, each FIR filter filtering a respective set of intermediate samples with a respective set of coefficients.

25. A computer program product, comprising:
a computer-readable medium comprising:
code for causing at least one computer to obtain, at a receiver, input samples comprising a desired signal transmitted by a transmitter having memory effects, and
code for causing the at least one computer to perform nonlinear equalization on the input samples to obtain equalized samples, the nonlinear equalization correcting for the memory effects of the transmitter.
